(19) United States
(12) Patent Application Publication
(10) Pub. No.: US 2008/0086064 A1
(43) Pub. Date: Apr. 10, 2008

(54) System and method for reducing and/or preventing anxiety in individuals

(75) Inventors: Raphael Rembrand, Kiryat-Tivon (IL); Eynat Gal, Timrat (IL)

Correspondence Address: Martin D. Moynihan;PRTSI, Inc., P.O. Box 16446, Arlington, VA, 22215, US

(73) Assignee: Carmel - Haifa University Economic Corporation Ltd., Haifa (IL)

(21) Appl. No.: 11/905,295

(22) Filed: Sep. 28, 2007

Related U.S. Application Data
(63) Continuation-in-part of application No. PCT/IL06/00386, filed on Mar. 27, 2006.
(60) Provisional application No. 60/666,739, filed on Mar. 29, 2005.

(51) Int. Cl. A61H 99/00

(52) U.S. Cl. 601/84

(57) ABSTRACT

A system and method for reducing anxiety in an individual by using an apparel device for applying various pressure to at least one selected body part of the individual. At least one physiological parameter indicative of the individual's anxiety level is measured and used for controlling the pressure applied by the apparel, in varying degrees and for varying periods of time, to at least one selected body part of the individual. The system is particularly useful for soothing and pacifying individuals suffering from a sensory modulation disorder, such as autism.

### RELATED APPLICATIONS

The present application is a continuation-in-part of PCT Patent Application No. PCT/IL2006/000386 filed Mar. 27, 2006 (Publication No. WO 2006/103660, published Oct. 5, 2006), which claims the benefit of U.S. Provisional Patent Application No. 60/666,739 filed Mar. 29, 2005, the contents of which are incorporated herein by reference.

### FIELD AND BACKGROUND OF THE INVENTION

The present invention relates to systems and methods for reducing anxiety in individuals in need, particularly in individuals affected with a sensory modulation disorder, such as autism.

Generally, subjects who are diagnosed with Pervasive Developmental Disorders (PDD), Attention Deficit Disorders (ADD) and Attention Deficit Hyperactivity Disorders (ADHD), have a Sensory Modulation Disorder (SMD); see. Baranek, G. T., Foster, L. G., & Berkson, G. (1997), Sensory Defensiveness in Persons with Developmental Disabilities, Occupational Therapy Journal of Research, 17, 173-185; Case-Smith, J, & Bryan, T. (1999); The Effects of Occupational Therapy with Sensory Integration Emphasis on Preschool Age Children with Autism, American Journal of Occupational Therapy, 53, 489-497; Case-Smith, J. & Miller, H. (1999); also, Occupational Therapy with Children with Pervasive Developmental Disorders, American Journal of Occupational Therapy, 53, 506-513.

Five disorders are identified under the category of Pervasive Developmental Disorders: (1) Autistic Disorder, (2) Rett's Disorder, (3) Childhood Disintegrative Disorder, (4) Asperger's Disorder, and (5) Pervasive Developmental Disorder Not Otherwise Specified, or PDDNOS.

Several devices and methods are known in the art for applying pressure to the body of the patient. Holding or squeezing techniques can be used by a therapist or caregiver. The therapist holds the patient and squeezes him or her firmly but in a controlled manner. This technique involves human touch, application of force, and some elements of control. Application of human touch between a therapist and patient raises strong ethical issues.

Restraining devices are used mostly when a person might cause damage to himself or his surroundings. These devices do not soothe the user; they just limit his movements, and their usage requires permits.

It has also been demonstrated that any form of nervous system stimulation (e.g. electricity) at periodic low frequencies (below 3 Hz) can create sleep, relaxation and other effects in any subject, as described for example, in U.S. Pat. No. 5,782,874.

### OBJECTS AND BRIEF SUMMARY OF THE INVENTION

One object of the present invention to provide a system that uses a lightweight, low cost wearable device applying deep pressure to soothe and pacify individuals suffering from anxiety, such as individuals suffering from a sensory modulation disorder e.g. autism. Another object of the invention is to provide a method using such a wearable device for soothing and pacifying individuals suffering from anxiety, and particularly individuals suffering from a sensory demodulation disorder such as autism.

According to one broad aspect of the present invention, there is provided a system for reducing anxiety in an individual in need, the system comprising:

an apparel constructed for wearing by the individual, and for covering at least one selected body part of the individual; and

a pressure applicator carried by the apparel and controllable for applying pressure in varying degrees, and for varying periods of time, to the at least one selected body part of the individual such as to reduce the level of anxiety in the individual.

According to a further feature in the described preferred embodiments, the system further comprises a measuring circuit for sensing and measuring at least one physiological parameter of the individual indicative of the individual's anxiety level, and for controlling the pressure applicator in response thereto.

The apparel is a non-restraining device, typically in the form of an inflatable vest including a plurality of cells applying pressure to the right and left sides of the individual's torso. Pressure is applied rhythmically with alternating periods of pressure and rest. When the apparel is a non-restraining device, usage of the apparel does not require legal authorization.

According to the invention, it is highly desirable to be able to scientifically measure or assess the variation in anxiety of a person in need, and the effectiveness of the pressure applied. The present invention, therefore, preferably includes measurement of one or more physiological parameters that are indicative of a person's stress or anxiety level. Such physiological parameters include, but are not limited to, the individual's, heart rate/variation, body temperature, galvanic skin response, differences in finger temperature, frontalis muscle activity, cardiovascular activity, blood pressure, pupils expansion, sweat, electrodermal responses, muscle tension, respiratory rate/variation and amplitude, brain wave, or any combination thereof.

When the individual in need wears the apparel, pressure is applied with varying degrees of strength and for varying degrees of time. The apparel can be made of multiple cells, wherein each cell can be regulated with its individual degree of pressure, and its individual time period for which said pressure is applied.

The system calculates the degree of pressure to be applied and its length of time based partially or wholly on the measurement of at least one of the above physiological measures obtained. Additionally, the system can take into consideration other personal parameters such as the person's gender, age, weight, height, medical history, treatment history, individual preference or any other parameter that has a relation to the level of anxiety or to the effectiveness of the pressure applied. The pressure level and the time period are responsive to the inputted one or more physiological parameters such as to provide the individual with a sense of well-being and soothing as needed. Preferably, the pressure is applied in pulses at a rate of at least one per second, e.g., one per 5-15 seconds, with each pulse separated by a time interval of at least one second, e.g., 24 seconds.

Pressure can be applied using gas, liquid, solid mechanical means (such as rotating cams) or any combination thereof.

The system may further comprise a neurostimulator activated to apply a weak stimulus (e.g. touch, sound, a fluctuating electric field), tuned to a frequency such as to excite a resonance in certain neural circuits in order to cause relaxation, sleepiness or slowing of targeted cortical processes in the individual.

According to another aspect of the present invention, there is provided a method for reducing anxiety in an individual in need by the use of a system as briefly described above.

As noted above, the system and method are particularly useful where the individual in need is one suffering from a sensory modulation disorder, such as autism.

Further features and advantages of the invention will be apparent from the description below.

### BRIEF DESCRIPTION OF THE DRAWINGS

The invention is described herein, by way of example only, with reference to the accompanying drawings, wherein:

FIG. 1 illustrates an apparel or garment for applying pressure to the upper body of a human being in accordance with the present invention;

FIG. 2 is a schematic illustration of the outer layer, and of the inner surface formed with inflatable cells, of the apparel of FIG. 1;

FIG. 3 is a schematic illustration in an end view of the portion of the apparel illustrated in FIG. 2;

FIG. 4 is a flow diagram showing how the applied pressure is controlled according to the subject's pulse, or other physiological parameter indicative of an anxiety condition;

FIG. 5 is a block diagram illustrating the overall system, including the compressor which is controlled for inflating the cells, in the apparel of FIG. 1 worn by the individual;

FIG. 6 schematically illustrates an apparel wherein the pressure is applied by rotary mechanical elements, such as cams; and

FIG. 7 illustrates another system constructed in accordance with the present invention which also includes a neurostimulator for applying a weak, fluctuating electrical field to the individual, besides a compressor for controlling the inflation of the cells in the apparel.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DETAILED DESCRIPTION OF PREFERRED EMBODIMENTS

As indicated above, the present invention can be used to reduce anxiety in an individual in need. It is based on the well-observed fact that mildly applied pressure on a person's body can have a pleasant, soothing or relaxing effect. This effect is helpful in alleviating anxieties when the individual is anxious or under stress. The invention can also be used to prevent anxiety (i.e., reduce it substantially to zero) when an individual experiences an event that can be stressful.

The invention is thus particularly useful for preventing anxiety in individuals suffering from autism, as well as other in other anxiety-prone individuals such as hyperactive or over-stimulated individuals that may need temporary soothing. The invention can also be used by anyone who is so handicapped, but is temporarily placed in an unusual or stressful situation, e.g., dental patients, air travelers, etc.

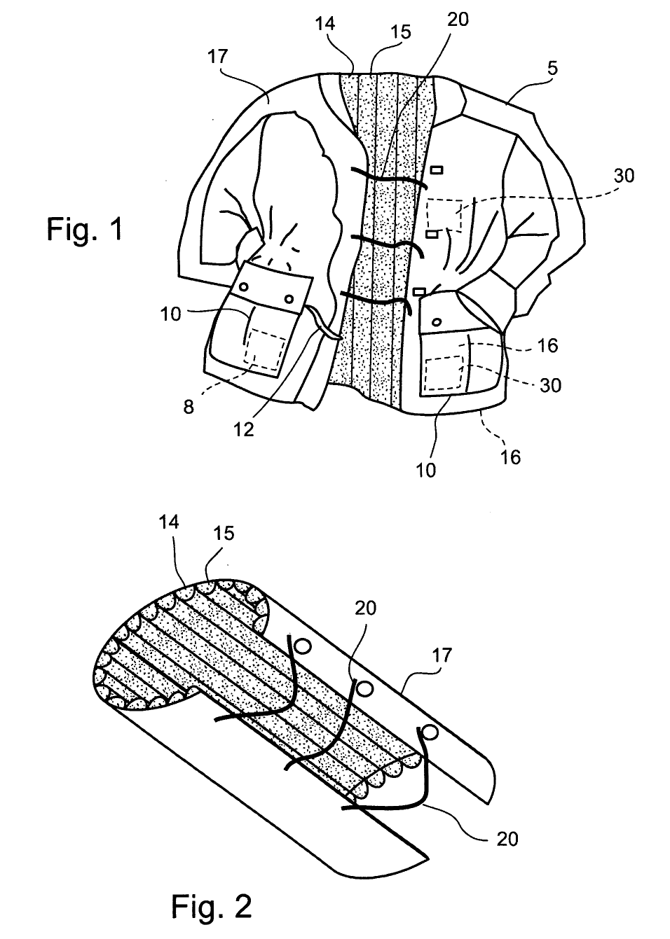

FIG. 1 illustrates an apparel in the form of a jacket 5 constructed in accordance with the invention adapted for applying varying pressure to selected body parts of an individual in need. Jacket 5 of FIG. 1 is inflatable by a compact air compressor carried by or integrated into the jacket 5. In the construction illustrated in FIG. 1, the air compressor, shown by broken lines 8, is integrated into a pocket 10 of the jacket. The invention can also use an external air compressor. The compact air compressor 8 is connected via air conducts 12 to a plurality of inflatable cells 14 and 15 defined by the inner surface of the jacket.

In order to improve the quality of the treatment and its accuracy, the system further includes a measuring circuit, schematically shown at 16, which may also be integrated in the same or another pocket 10. Circuit 16 includes a sensor, schematically shown at 30, as well as other sensors (not shown), such as finger probes, forehead probes, etc., for sensing and measuring one or more physiological parameters that are indicative of a person's stress or anxiety level.

Examples of such physiological parameters to be measured include: heart rate, body temperature, galvanic skin response, differences in finger temperature, frontalis muscle activity, cardiovascular activity (the electrocardiogram [ECG], relative pulse volume [RPV], and digit skin temperature), blood pressure, pupils expansion, sweat, electrodemmal responses (skin conductance), muscle tension, respiratory rate and amplitude, brain wave or any combination thereof. Multiple measurements can be made, and indicators can be provided, for each physiological parameter measured. It is preferred to measure physiological parameters that can be easily measured in a non-invasive and non-intrusive manner.

According to the invention, the apparel is provided with means for applying varying pressure to selected body parts of the individual in need. The pressure can vary both in its strength and in the length of time it is applied. Preferably, the pressure is applied as pulses at a rate of a pulse per one or more seconds, e.g., one pulse per 5-15 seconds, with each pulse separated by a time interval of at least one second, e.g., 2-4 seconds.

In order to administer the treatment in a manner which is most effective, the degree of pressure applied by the system, and the period of time for which said pressure is applied, are wholly or partially based on the value or values of at least one physiological parameter measured. The anxiety parameters can be measured with respect to a reference value manner in order to best determine the anxiety level of the individual.

In one embodiment of the present invention, the degree of pressure applied, and the time period the pressure is applied, also take into consideration personal parameters of the respective individual. The same physiological parameter value can have a different significance according to personal parameters of the individual. Such personal parameters include, but are not limited to: age, gender, weight, height, medical history, medication intake, treatment history, physical fitness, individual preference, or any combination thereof. For example, a given heart rate at rest is interpreted differently whether the person is young or old, is overweight or not, is physically fit or not, is currently taking medication that affects the heart rate, etc.

Preferably, the apparel of the invention is non-restraining, since restraining devices cannot be used without legal authorization.

In the described preferred embodiment of the invention, the apparel includes an outer layer 17 and a plurality of cells 14 and 15 defined by the inner surface of the outer layer 17. The inner surface defining the cells 14, 15, and the outer layer 17, have an elasticity such that when the pressure in the cells is increased, the apparel applies the pressure to the respective body part of the individual contacted by the cells.

In the described embodiment of the present invention, the apparel includes means for tightening the outer layer 17 of the apparel. Such means are shown in FIGS. 1 and 2 as including snap links 20, but could also include a belt, strapped loops, a fastener such as Velcro™, a band, etc.

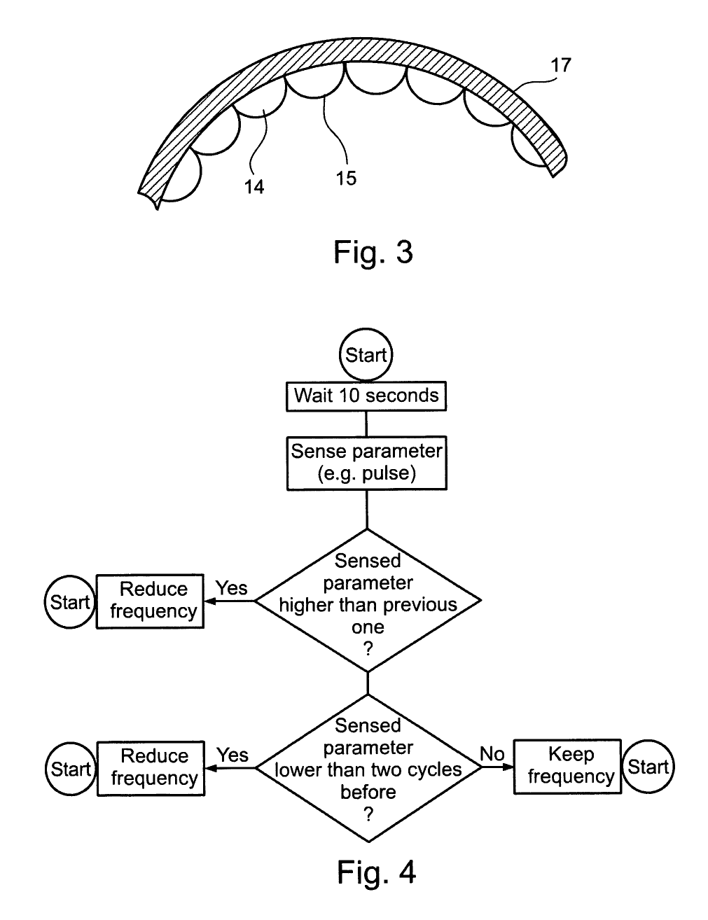

FIG. 2 is a schematic illustration of the outer layer 17 and the inflatable cells 14 and 15 defined by the inner layer of the apparel of FIG. 1. FIG. 3 is a schematic illustration of an end view of the outer layer 17 and the inflatable cells 14 and 15 of FIG. 2.

FIG. 4 is a flowchart of an example of a process controlling the frequency of the applied pressure, based on a measurement of the subject's pulse. In this example, the system takes a pulse measurement every ten seconds. If the pulse measurement is higher than the previous pulse measurement, or lower than that taken in the two preceding cycles, then the frequency is reduced; if it is not higher than the previous one, but not lower than that taken in the two preceding cycles, then the frequency is kept the same.

Preferably, the pressure can be applied to any body part except the head, chest, abdomen and genitals. Preferably, each of the cells can be pressurized individually with respect to both the pressure value, and the time period. By controlling the pressure applied to each individual cell, e.g., by including a control valve in each line from the compressor, the quality and effectiveness of the treatment can be maximized.

The outer fabric layer 17 is flexible enough to adapt itself to the individual's body, and yet is sturdy enough so that the pressure is directed against the individual's body.

Several means are known for regulating the pressure applied to each cell. In the embodiment of the invention illustrated in FIGS. 1-5, the cells may be pressurized by inflation or deflation controlled by valves (not shown) in lines from the compressor 8 to each cell. The cells can be inflated by a gas, e.g., a single gas or a combination of gases such as air, or by a liquid, such as water.

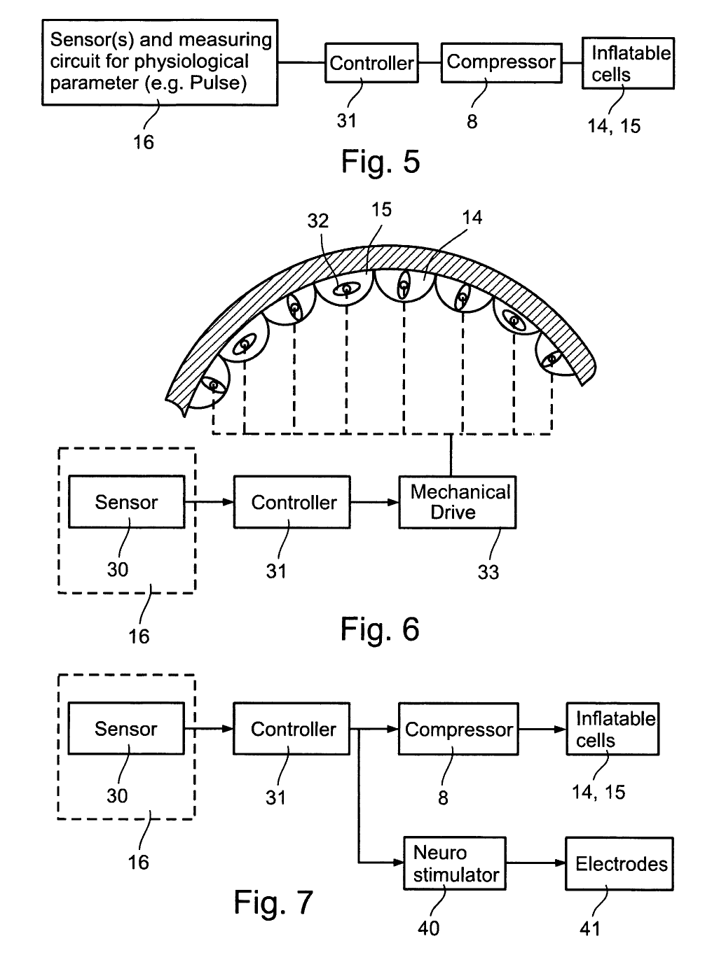

FIG. 5 is a block diagram illustrating the system as described above. The system includes a measuring circuit 16 having a sensor 30 for each physiological parameter (e.g., heart beat) to be measured and to be used for controlling the application of the pressure pulses. The illustrated system also includes a controller 31 for controlling the compressor 8, and/or the valves (not shown) in its feed lines for pressurizing and depressurizing the inflatable cells 14, 15 in response to the measured physiological parameter(s) of interest. As indicated above, particularly good results are obtainable when the pressure is applied in the form of pulses at a rate of one per one or more seconds, preferably one per 5-15 seconds, each separated by a time interval of at least one second, preferably 2-4 seconds.

The pressure pulses may also be applied by mechanical means, non-rotatable or rotatable. FIG. 6 schematically illustrates such a construction, wherein each cell includes a rotatable camshaft 32, rotatable by a mechanical drive 33 and having cam surfaces to apply the pressure pulses to the individual upon the rotation of the camshafts 32. Rotation of each camshaft 32 is controlled by the sensor(s) in measuring circuit 16, for sensing the physiological parameter (or parameters) of interest via controller 31. The camshafts 32 may be coupled to the mechanical drive 33 in the same phase, so as to apply all the pressure pulses simultaneously; alternatively, the camshafts 32 may be coupled in different phases to the mechanical drive 33, so as to apply the pressure pulses to the individual in different phases.

The system can operate in a manual mode wherein the individual in need initiates and regulates the pressure administered to him or her. Alternatively, a caregiver may regulate the degree, and the length of time, pressure is applied to selected body parts of the individual. The term “caregiver” as referred to herein means a doctor, an occupational therapist, a nurse, a trainer, a coach, a physiotherapist, a healthcare professional, a family member, a friend or any person assuming such tasks. The caregiver watches the values measured for the different physiological parameters, and based on these values and the individual parameters of the person in need, makes a decision how to regulate the pressure in order to prevent, and/or to reduce, the anxiety level of the individual in need. Naturally, the caretaker can also base his/her decisions of how to regulate the pressure on his/her personal experience and knowledge and on his/her evaluation of how the individual in need is responding.

Under normal conditions, the pressure applied should be at least 1 PSI (52 mm Hg), and should not exceed 5-6 PSI (250-300 mm Hg), that is twice the blood pressure of a normal individual.

The apparel may also include means, shown as snap links 20, for tightening the outer layer 17 of the apparel. The tightening mechanism assures that the apparel fits close to the individual's body. The tightening may apply an initial pressure. In addition, by using a tightening mechanism, the apparel can fit people of different sizes since even if the apparel is a little to big initially for a person, after tightening it, the apparel may fit close to that person's body. The tightening means may also include: a belt, strapped loops, a fastener such as Velcro™, a band, etc.

Preferably, all the parts of the system are small and light so the system can be easily worn or folded into a backpack.

FIG. 7 schematically illustrates yet another embodiment of the present invention wherein the system further includes neurostimulation means shown at 40. As shown in FIG. 7, “neurostimulation” may include the effect obtained when electric currents are passed through the brain, the spinal cord, an organ, or peripheral nerves. The electric current is usually delivered by contact electrodes 41, i.e., electrodes that are in ohmic contact with the biological tissue. Research has shown that weak fluctuating electric fields applied externally to the skin of an individual can cause relaxation and doziness. The frequency of the electric field should be such as to excite a resonance in certain neural circuits in order to cause relaxation, sleepiness or slowing of targeted cortical processes in the individual. In the experiments performed, the electric field was applied predominantly to skin areas away from the head, thereby avoiding substantial polarization current densities in the brain.

FIG. 7 schematically illustrates such an arrangement wherein the system includes, not only the neural stimulator 40 and the electrodes 41, but also the inflatable cells 14, 15, whose inflation is effected by compressor 8 controlled by a controller 31, which is in turn controlled by the sensor(s) 30 in a measuring circuit 16 for sensing and measuring one or more physiological parameters of interest, as described above with respect to FIG. 5.

It appears that the external electric field somehow influences somatosensory or visceral afferent nerves, which report the effect to the brain. Although the mechanism whereby the field acts on the afferents is unknown, the effect apparently takes the form of a slight modulation of the firing patterns of the nerves, because the polarization current densities induced by the field are much too small to cause firing of the nerves. If the applied external field is periodic, so will be the modulation of the firing patterns of affected afferent fibers, and the brain is then exposed to an evoked periodic signal input. Apparently, this signal input influences certain resonant neural circuits, the state of which has observable consequences.

The excitation of sensory resonances through modulation of afferents allows the use of small electric field generators that may be battery-operated. To be effective, the fluctuating electric field need not be sinusoidal or even periodic. The field may have a complicated spectral power density, as long as the dominant frequency is close to the resonant frequency of the sensory resonance of interest.

“Neurostimulation”, however, may also include other forms of stimuli (e.g., touch, sound) tuned to a frequency to excite a resonance in certain neural circuits in order to cause relaxation, sleepiness or slowness of targeted cortical processes in the individual.

While the invention has been described above with respect to several preferred embodiments, it will be appreciated that these are set forth merely for purposes of example, and that many other variations, modifications and applications of the invention may be made.

What is claimed is:

1. A system for reducing anxiety in an individual, said system comprising:
an apparel constructed for wearing by the individual, and for covering at least one selected body part of the individual; and
a pressure applicator carried by said apparel and controllable for applying pressure, at periodic intervals, in varying degrees and for varying periods of time, to said at least one selected body part of the individual such as to reduce the level of anxiety in said individual.

2. The system according to claim 1, wherein said system further comprises a measuring circuit for sensing and measuring at least one physiological parameter of the individual indicative of the individual's anxiety level, and for controlling said pressure applicator in response thereto.

3. The system according to claim 2, wherein said measuring circuit controls said pressure applicator according to one or more of the following physiological parameters: heart rate, body temperature, galvanic skin response, differences in finger temperature, frontalis muscle activity, cardiovascular activity, electro-cardiac activity, blood pressure, pupils expansion, sweat, electrodermal responses, muscle tension, respiratory rate and amplitude, brain wave, or any combination thereof.

4. The system according to claim 1, wherein said system further includes an input device for inputting one or more personal parameters of said individual used by said measuring circuit, in determining the degree of pressure to be applied and the time period said pressure is to be applied.

5. The system according to claim 4, wherein said personal parameters include: age, gender, weight, height, medical history, medication intake, treatment history, physical fitness of said individual, or any combination thereof.

6. The system according to claim 1, wherein said apparel is non-restraining and includes an outer layer and a plurality of cells defined by an inner surface of said outer layer, said inner surface having an elasticity such that an increase in pressure in said cells is transmitted by said cells to at least one selected body part of the individual.

7. The system according to claim 6, wherein said apparel is constructed such that each of said cells can be pressurized individually.

8. The system according to claim 6, wherein said cells are inflatable by a gas or a liquid.

9. The system according to claim 1, wherein said pressure applicator includes a plurality of localized pressure applying mechanical devices.

10. The system according to claim 1, wherein said pressure applicator applies pressure in the form of pulses at a rate of one pulse per 5-15 seconds, each separated by a time interval of 2-4 seconds.

11. The system according to claim 1, wherein said apparel includes tightening means for tightening the outer layer of the apparel.

12. The system according to claim 1, wherein said system further comprises a neurostimulator.

13. The system according to claim 11, wherein said neurostimulator is an electrical neurostimulator which applies a weak, fluctuating electric field tuned to a frequency such as to excite a resonance in certain neural circuits in the individual in order to cause relaxation, sleepiness or slowing of targeted cortical processes in the individual.

14. A method for reducing and/or preventing anxiety in an individual, said method comprising:
dressing to said individual with an apparel capable of supplying pressure to at least one selected body part of the individual; and
controlling said apparel to apply varying degrees of pressure, and for varying periods of time, to said at least one selected body part of the individual to reduce the anxiety level in said individual.

15. The method according to claim 14, further comprising measuring at least one physiological parameter of the individual indicative of the individual's anxiety level; and controlling said pressure applicator in response to said measurement.

16. The method according to claim 15, wherein said physiological parameter is one or more of: heart rate, body temperature, galvanic skin response, differences in finger temperature, frontalis muscle activity, cardiovascular activity, electro cardiac activity, blood pressure, pupils expansion, sweat, electrodermal responses, muscle tension, respiratory rate and amplitude, brain wave or any combination thereof.

17. The method according to claim 14, wherein said degree of pressure applied and the time period said pressure is applied, are varied by personal parameters of said individual.

18. The method according to claim 17, wherein said personal parameters include: age, gender, weight, height, medical history, medication intake, treatment history, physical fitness of said individual, or any combination thereof.

19. The method according to claim 14, wherein said apparel is non-restraining and includes an outer layer, and a plurality of cells defined by an inner surface of said outer layer, said inner surface having an elasticity such that an increase in pressure in said cells is transmitted by said cells to said at least one selected body part of said individual.

20. The method according to claim 19, wherein said cells are pressurized individually.

21. The method according to claim 19, wherein said plurality of cells are inflatable by a gas or a liquid.

22. The method of claim 14, wherein said pressure is applied by rotary mechanical devices.

23. The method according to claim 14, wherein said pressure is applied in pulses at a rate of one pulse per 5-15 seconds, with each pulse separated by a time interval of 2-4 seconds.

24. The method according to claim 19, wherein the outer layer of said apparel is tightened by a belt, strapped loops, a fastener, snap links or a band.

25. The method of claim 14, further comprising actuating a neurostimulator to apply a weak, fluctuating stimulus tuned to a frequency such as to excite a resonance in certain neural circuits in order to cause relaxation, sleepiness or slowing of targeted cortical processes in said individual.

26. The method according to claim 14, wherein said individual is one suffering from a sensory modulation disorder.

27. The method according to claim 26, wherein said sensory modulation disorder is autism.
